(19) United States
(12) Patent Application Publication
(10) Pub. No.: US 2025/0336002 A1
(43) Pub. Date: Oct. 30, 2025

(54) ARTIFICIAL INTELLIGENCE BASED SYSTEMS AND METHODS FOR DOCUMENT CLASSIFICATION AND ANALYSIS

(71) Applicant: State Farm Mutual Automobile Insurance Company, Bloomington, IL (US)

(72) Inventors: Yuntao Li, Champaign, IL (US); Dingchao Zhang, Normal, IL (US)

(21) Appl. No.: 19/263,338

(22) Filed: Jul. 8, 2025

Related U.S. Application Data
(63) Continuation of application No. 16/529,086, filed on Aug. 1, 2019, now abandoned.

(51) Int. Cl. G06Q 40/08; G06N 3/08; G06Q 10/10; G06V 30/416

(52) U.S. Cl. CPC G06Q 40/08; G06N 3/08; G06Q 10/10; G06V 30/416

(57) ABSTRACT

An image analysis (IA) computer system for classifying and analyzing received claim documents includes a processor in communication with a memory device. The processor is programmed to: receive an insurance claim request including (i) image data representing a document associated with an insurance claim, and (ii) an identifier of the insurance claim; execute an extraction module to extract document content from the image data; execute a classification module to classify the document; execute a content verification module to verify the document content based upon the document type; when the document content is verified: (a) apply the document content to the insurance claim; (b) transmit an insurance claim response indicating the document content was verified; and (c) process the insurance claim; and when the document content is not verified: (a) update the insurance claim with a denial indicator; and (b) transmit an insurance claim response indicating the insurance claim is denied.

### CROSS-REFERENCE TO RELATED APPLICATIONS

This application is a continuation of and claims priority to U.S. patent application Ser. No. 16/529,086, filed Aug. 1, 2019, which is hereby incorporated herein by reference in its entirety.

### FIELD OF THE INVENTION

The present disclosure relates to image identification and processing, and, more specifically, to artificial intelligence (AI)-based methods and systems for identifying content within received images and classifying the content for further analysis.

### BACKGROUND

In the insurance industry, it is common for policyholders to submit documents during an insurance claim process, such as a driver's license or policy card, vehicle repair bills, medical bills, and the like. These documents are intended to provide evidence to an insurance provider of a person's identity, or of the actual costs associated with the incident that initiated the insurance claim.

In at least some cases, human personnel are tasked with identifying and reviewing these documents as they are received from policyholders. These personnel must properly identify the type of document and, in addition, must analyze the identified document for relevant details, such as policy numbers, policyholder identifiers, charges or invoice amounts, billing or medical codes, and the like. These tasks are tedious and prone to error. Moreover, recognizing various codes, acronyms, and/or other vendor-specific items on a document can be difficult or require specialized expertise.

In addition, it is difficult for a human analyst to recognize whether certain costs are appropriate. For example, a human analyst may be unable to determine an appropriate charge for a bumper repair or replacement from a vehicle repair vendor. Accordingly, if a policyholder submits an invoice for reimbursement during the claims process, the human analyst may erroneously approve a fraudulent charge.

Employing human analysts to identify documents and to analyze the data therein can be time intensive, labor intensive, and inefficient, especially when it comes to analyzing large volumes of data for claims processing and/or for analyzing specialized data.

### BRIEF SUMMARY

The present embodiments may relate to systems and methods for classifying received documents, identifying relevant data therein, and analyzing the relevant data for fraud. An image analysis (“IA”) computer system, as described herein, may include an image analysis (“IA”) server in communication with one or more user computing devices and/or one or more insurer network computing devices. The IA computer system may be programmed to: (a) receive, from a user computing device associated with an insurance policyholder, an insurance claim request including (i) image data representing a document associated with an insurance claim, and (ii) an identifier of the insurance claim; (b) execute an extraction module to extract document content of the document from the image data; (c) execute a classification module to classify the document as one document type of a plurality of document types, wherein the classification module applies a document classification model to the extracted document content; (d) execute a content verification module to verify the extracted document content based upon the document type of the document; (e) when the extracted document content is verified: (i) apply the extracted document content to the insurance claim identified by the received identifier to update the insurance claim; (ii) transmit an insurance claim response to the user computing device indicating the extracted document content was verified and applied to the insurance claim; and (iii) process the updated insurance claim; and (f) when the extracted document content is not verified: (i) update the insurance claim identified by the received identifier with a denial indicator; and (ii) transmit an insurance claim response to the user computing device indicating the insurance claim is denied based upon the extracted document content not being verified.

In one aspect, an image analysis (IA) computer system for classifying and analyzing received claim documents using artificial intelligence is provided. The IA computer system includes at least one processor in communication with at least one memory device. The at least one processor is programmed to: (a) receive, from a user computing device associated with an insurance policyholder, an insurance claim request including (i) image data representing a document associated with an insurance claim, and (ii) an identifier of the insurance claim; (b) execute an extraction module to extract document content of the document from the image data; (c) execute a classification module to classify the document as one document type of a plurality of document types, wherein the classification module applies a document classification model to the extracted document content; (d) execute a content verification module to verify the extracted document content based upon the document type of the document; (e) when the extracted document content is verified: (i) apply the extracted document content to the insurance claim identified by the received identifier to update the insurance claim; (ii) transmit an insurance claim response to the user computing device indicating the extracted document content was verified and applied to the insurance claim; and (iii) process the updated insurance claim; and (f) when the extracted document content is not verified: (i) update the insurance claim identified by the received identifier with a denial indicator; and (ii) transmit an insurance claim response to the user computing device indicating the insurance claim is denied based upon the extracted document content not being verified. The computer system may include addition, less, or alternate functionality, including that discussed elsewhere herein.

In another aspect, a computer-implemented method for classifying and analyzing received claim documents using artificial intelligence is provided. The method is implemented using an IA computer system including at least one processor in communication with at least one memory device. The method includes: (a) receiving, from a user computing device associated with an insurance policyholder, an insurance claim request including (i) image data representing a document associated with an insurance claim, and (ii) an identifier of the insurance claim; (b) executing an extraction module to extract document content of the document from the image data; (c) executing a classification module to classify the document as one document type of a plurality of document types, wherein the classification module applies a document classification model to the extracted document content; (d) executing a content verification module to verify the extracted document content based upon the document type of the document; (e) when the extracted document content is verified: (i) applying the extracted document content to the insurance claim identified by the received identifier to update the insurance claim; (ii) transmitting an insurance claim response to the user computing device indicating the extracted document content was verified and applied to the insurance claim; and (iii) processing the updated insurance claim; and (f) when the extracted document content is not verified: (i) updating the insurance claim identified by the received identifier with a denial indicator; and (ii) transmitting an insurance claim response to the user computing device indicating the insurance claim is denied based upon the extracted document content not being verified. The method may include additional, fewer, or alternate steps, including those discussed elsewhere herein.

In a further aspect, at least one non-transitory computer-readable storage medium having computer-executable instructions embodied thereon is provided. When executed by at least one processor of an image analysis (IA) computer system, the computer-executable instructions cause the at least one processor to: (a) receive, from a user computing device associated with an insurance policyholder, an insurance claim request including (i) image data representing a document associated with an insurance claim, and (ii) an identifier of the insurance claim; (b) execute an extraction module to extract document content of the document from the image data; (c) execute a classification module to classify the document as one document type of a plurality of document types, wherein the classification module applies a document classification model to the extracted document content; (d) execute a content verification module to verify the extracted document content based upon the document type of the document; (e) when the extracted document content is verified: (i) apply the extracted document content to the insurance claim identified by the received identifier to update the insurance claim; (ii) transmit an insurance claim response to the user computing device indicating the extracted document content was verified and applied to the insurance claim; and (iii) process the updated insurance claim; and (f) when the extracted document content is not verified: (i) update the insurance claim identified by the received identifier with a denial indicator; and (ii) transmit an insurance claim response to the user computing device indicating the insurance claim is denied based upon the extracted document content not being verified. The computer-executable instructions may include addition, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a schematic diagram of an exemplary image analysis (IA) computer system for document classification and analysis using artificial intelligence and machine learning techniques;

FIG. 2 illustrates an exemplary configuration of a user computing device as shown in FIG. 1, in accordance with one embodiment of the present disclosure;

FIG. 3 illustrates an exemplary configuration of a server system as shown in FIG. 1, in accordance with one embodiment of the present disclosure;

FIGS. 4A-4C illustrate a flowchart of an exemplary computer-implemented process implemented by the IA computer system shown in FIG. 1 for document classification and analysis;

FIG. 5 illustrates a flow diagram of the IA computer system shown in FIG. 1 implementing the process shown in FIGS. 4A-4C to classify and analyze documents associated with an insurance claim in accordance with one aspect of the present disclosure;

FIG. 6 illustrates a schematic diagram of the IA computer system shown in FIG. 1 implementing the process shown in FIGS. 4A-4C;

FIG. 7 illustrates an example screenshot of a claim processing screen from the IA server depicting classifying and verifying a driver's license document, in accordance with one embodiment of the present disclosure;

FIG. 8 illustrates an example screenshot of a claim processing screen from the IA server depicting classifying and verifying a vehicle repair invoice document, in accordance with one embodiment of the present disclosure; and

FIG. 9 illustrates an example screenshot of a claim processing screen from the IA server depicting classifying and verifying a medical care invoice document, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, improved systems and methods for document classification, analysis, and verification, particularly in insurance claims processing. The systems and methods described herein overcome the deficiencies of other known systems. In one exemplary embodiment, the process may be performed by an image analysis (“IA”) server. In the exemplary embodiment, the IA server may be a web server that may be in communication with at least one user computing device and an insurer provider computing device and/or network.

When a policyholder submits an insurance claim, the insurance provider (also referred to as an “insurer”) that provides the policy on which the policyholder is making the claim will often request one or more documents from the policyholder. For example, in at least some instances, the insurer requests a copy of a valid driver's license or other identification, in order to verify the policyholder's identity to proceed with processing the claim.

In some instances, such as where the policyholder submits an insurance claim related to damage to their insured vehicle, the insurer requests a copy of a vehicle repair invoice. As used herein, a vehicle repair invoice may refer generally to any bill or invoice of actual services performed and/or to estimates provided before services are performed, as generated and provided to the policyholder by a vehicle repair provider or vendor. The insurer may review the vehicle repair invoice to ensure the cost(s) for repair of the vehicle are appropriate.

In still other instances, such as where the policyholder submits an insurance claim related to a personal injury to the policyholder or other insured person(s), the insurer requests a copy of a medical care invoice. As used herein, a medical care invoice may refer generally to any bill or invoice of actual services performed and/or to estimates proved before services are performed, as generated and provided to the policyholder by a medical care provider. The insurer may review the medical care invoice to ensure the cost(s) for medical care are appropriate and/or the rendered or to-be-rendered services are commensurate with any indicated injury.

In the exemplary embodiment, the IA server is configured to receive an insurance claim request from the policyholder. In the exemplary embodiment, the IA server receives the insurance claim request from a user computing device of the policyholder. The insurance claim request is associated with an existing insurance claim and, as such, includes an identifier of the insurance claim. The insurance claim request further includes image data representing a document associated with the insurance claim. For example, the policyholder captures an image of the document using their user computing device (e.g., taking a picture using an integral camera) and/or any other image-capture device (e.g., a separate scanner). The document may be, for example, a driver's license (or other identification), a vehicle repair invoice, or a medical care invoice. In other examples, the document may include any document that may be requested and/or required during processing of an insurance claim, such as a police report, a medical evaluation, images depicting “before and after” status of an insured item, and/or the like. In some embodiments, the IA server may be configured to receive and/or process video data in addition to image data, according to the methods described herein (e.g., by analyzing particular frames of the video data as individual images and/or by using video-specific versions of various analyses).

To implement the process(es) described herein to classify and analyze documents, the IA server may execute one or more modules using a processing component. The one or modules may include specialized instruction sets or kernel extensions that, upon execution by the processor, cause the processor to perform the functions described herein. The modules may additionally or alternatively include co-processors specifically programmed to perform the described functions.

Initially, the IA server is configured to classify the document, or to identify what type of document is represented in the received image data. In one exemplary embodiment, the IA server is configured to classify the document as one document type of a plurality of document types. In one particular embodiment, the document types are driver's license, vehicle repair invoice, and medical care invoice. As described above, however, the document types may include any number of additional and/or alternative document types.

To classify the document, the IA server may initially execute an extraction module to extract document content from the image data. As used herein, “document content” may include at least one of document text and document images from the represented document. The content extraction module may include, for example, image processing functionality that identifies text and/or images within the image data and extracts the text and/or images as analyzable data sets (i.e., the document content). Document content may include the actual content (e.g., images and/or texts) as well as characteristics thereof, such as placement, size/scale, formatting, and the like. For instance, document content may include an image as well as data indicating that the image is a particular size and located on a left-hand side of the document.

The IA server is further configured to execute a classification module to classify the document as one document type of a plurality of document types. In one exemplary embodiment, the classification module applies a document classification model to the extracted document content. In some embodiments, the document classification model includes at least one of a conditional neural network optical character recognition (OCR) model, a long short term memory (LSTM) OCR model, and a template matching model. In some embodiments, the document classification model is built based upon training data sets of document content of historical and/or example documents of the plurality of document types.

For example, the IA server may store, in at least one memory device, a training set of driver's license document content. The training set of driver's license document content may include historical driver's license document content, or driver's license data that has been submitted to the IA server in one or more historical insurance claims. Additionally or alternatively, the training set of driver's license document content may include example driver's license document content that is not associated with any real driver's licenses but is instead representative of “typical” driver's license document content, such as sample names, alphanumeric driver's license identifiers, sample addresses, sample images, and the like. The IA server may execute a training module to train the classification module based upon the training set of driver's license document content, and may build the document classification model based on the training.

Additionally or alternatively, the IA server may store, in at least one memory device, a training set of vehicle repair invoice document content. The training set of vehicle repair invoice document content may include historical vehicle repair invoice document content, or vehicle repair invoice data that has been submitted to the IA server in one or more historical insurance claims. Additionally or alternatively, the training set of vehicle repair invoice document content may include example vehicle repair invoice document content that is not associated with any real vehicle repair invoices but is instead representative of “typical” vehicle repair invoice document content, such as sample names, sample repair or maintenance services, associated numeric costs, and the like. The IA server may execute a training module to train the classification module based upon the training set of vehicle repair invoice document content, and may build the document classification model based on the training.

Additionally or alternatively, the IA server may store, in at least one memory device, a training set of medical care invoice document content. The training set of medical care invoice document content may include historical medical care invoice document content, or medical care invoice data that has been submitted to the IA server in one or more historical insurance claims. Additionally or alternatively, the training set of medical care invoice document content may include example medical care invoice document content that is not associated with any real medical care invoices but is instead representative of “typical” medical care invoice document content, such as sample names, sample medical care services, associated numeric costs, and the like. The IA server may execute a training module to train the classification module based upon the training set of medical care invoice document content, and may build the document classification model based on the training.

It should be readily understood that the document classification model may be built based on training from any number of data sets associated with any number of document types such that the document classification model, when applied to document content, is configured to classify the document content as one of the document types.

In some embodiments, the document classification module applies the document classification model, which outputs a confidence score representing a likelihood that the document is a particular document type. Moreover, the document classification model outputs a confidence score for the document for each of the plurality of document types. The document classification module orders the confidence scores, for example, from lowest to highest or highest to lowest. The document classification module subsequently classifies the document as one of the document types based upon the highest output confidence score.

Based upon the document type of the document, as identified by the document classification module, the IA server is further configured to execute a content verification module to verify the extracted document content. As used herein, “verification” refers to determining if the document content (and, therefore, the document from which the document content is extracted) is (i) associated with the policyholder, (ii) real (i.e., not forged or otherwise fake), and/or (iii) appropriate to the associated insurance claim. For example, “verification” of a vehicle repair invoice may include determining whether a charged or estimated amount for a particular repair service (e.g., taillight replacement) is appropriate.

“Appropriate,” as used herein, refers to a value within a predetermined range including an average and/or median amount, such as within two standards of deviation of the median/average amount for a service or within a predefined percentage of the median/average amount (e.g., within 50% of the median/average amount). In some embodiments, the predetermined range may be more limited with respect to values above the median/average amount than with respect to values below the median/average amount. For example, the predetermined range may be defined as zero to no more than 40% above the median/average amount, such that any amount below the median/average amount is considered appropriate. If an “inappropriate” amount, which is an outlier and falls outside of the predetermined range, is charged for a service, a vehicle repair invoice including the inappropriate amount is considered “unverified,” in the context of the present disclosure. In this way, fraudulent or excessive charges from a service provider may be declined by the insurer.

In one example, where the document is classified as a driver's license (i.e., the document type of the document is “driver's license”), executing the content verification module may include performing at least one of (a) key point matching based upon the extracted document content and stored data associated with the policyholder (e.g., matching between the received image data representing the driver's license and stored image data representing the driver's license), and (b) fake/real classification. If the key point matching is successful (e.g., the image data received in the insurance claim request matches the stored image data), the document content is verified. If the key point matching is unsuccessful (e.g., the image data received in the insurance claim request does not match the stored image data), the document content is not verified. Likewise, if the outcome of the fake/real classification is that the driver's license represented in the image data is real, the document content is verified. Likewise, if the outcome of the fake/real classification is that the driver's license represented in the image data is not real (e.g., is likely fake), the document content is not verified.

In another example, where the document is classified as a vehicle repair invoice (i.e., the document type of the document is “vehicle repair invoice”), executing the content verification module may include performing anomaly detection based upon the extracted document content and stored historical vehicle repair invoice data. In such examples, the content verification module determines, based upon the extracted document content, at least one vehicle repair service identified by the document and an associated charge for each at least one vehicle repair service. The content verification module retrieves stored historical vehicle repair invoice data including historical vehicle repair services and associated charges. The content verification modules determines an average or median charge for each at least one vehicle repair service identified by the document, and also determines whether the associated charge, as identified by the document, is appropriate (e.g., within a predetermined range of the median/average charge). If all charges associated with all at least one vehicle repair services identified in the document are determined to be appropriate, the document content is verified. In some embodiments, if one or more charge(s) is inappropriate, the document content is not verified.

Likewise, in cases where the document is classified as a medical care invoice (i.e., the document type of the document is “medical care invoice”), executing the content verification module may include performing anomaly detection based upon the extracted document content and stored historical medical care invoice data. In such examples, the content verification module determines, based upon the extracted document content, at least one medical care service identified by the document and an associated charge for each at least one medical care service. The content verification module retrieves stored historical medical care invoice data including historical medical care services and associated charges. The content verification modules determines an average or median charge for each at least one medical care service identified by the document, and also determines whether the associated charge, as identified by the document, is appropriate (e.g., within a predetermined range of the median/average charge). If all charges associated with all at least one medical care services identified in the document are determined to be appropriate, the document content is verified. In some embodiments, if one or more charge(s) is inappropriate, the document content is not verified.

In general, when the extracted content is verified, the IA server is configured to notify the policyholder that the insurance claim request was approved and to apply the document content to the associated insurance claim. For example, the IA server may process the insurance claim and/or initiate reimbursement to the policyholder of an amount equal to a total of all appropriate charges. When the extracted content is not verified, the IA server is configured to notify the policyholder that the insurance claim request was denied and to update the associated insurance claim with an indicator that unverified content was provided by the policyholder.

In some embodiments, if one or more charges (e.g., one or more vehicle repair service or medical care service charges) is inappropriate, the document content of the document associated therewith may be classified or labelled as “provisionally” unverified by the content extraction module. The IA server may be configured to transmit an advisory response to the policyholder indicating that the document content is provisionally unverified and identifying the one or more inappropriate charges. The IA server may deny the insurance claim request but also prompt the user to submit a new document with appropriate charges. Alternatively, the IA server may provisionally approve the insurance claim request, as described further herein, but only for the appropriate charges. The IA server may alert the policyholder that the insurance claim request is provisionally approved but also prompt the user to submit a new document with appropriate charges for the service(s) for which the inappropriate charges were identified.

In at least some embodiments, the IA server is further configured to use the document submitted and analyzed as described above to perform trend analysis and/or claims processing predictions. More particularly, the IA server is configured to leverage historical claims data and the data associated with the insurance claim request (e.g., the claim identifier, the document content as classified and/or verified, etc.) to identify and/or analyze overall trends in insurance claims and to provide information to a policyholder and/or claim analyst about the lifecycle of the individual insurance claim. Where the IA server performs such trend analysis, the IA server may provide the results of the analysis back to one or more internal models as model feedback. For example, where trend analysis indicates that charges for particular medical care services are rising year over year, the IA server may update its internal verification models to expand the range of appropriate charges for that service.

Moreover, the IA server may be further configured to incorporate document content verified using the above-described process into existing training sets and/or models. The IA server may store verified document content in a particular memory location for access by one or more modules, such that the verified document content may be used to update models. In this way, the document classification model and/or models used by the content verification module are dynamically updated and maintained with up- to-date data sets.

The IA server is configured to facilitate automated processing and analysis of documents submitted to an insurance provider for an insurance claim, using machine learning and interactive user interface design. The IA server is configured to automatically identify document categories (e.g., driver's license, vehicle repair invoice, medical care invoice, etc.), extract relevant and useful information, and generate predictions on likelihood of fraud, line item estimates, and next best actions in the claims process. Information is organized into an interactive user interface with an easy-to-navigate layout and functionalities, as described further herein.

The IA server is configured to build a document classification model based upon training with insurance claim-specific document and to leverage specific document templates, claim-specific terminologies to optimize its functionality. In some embodiments, the document classification model is built based upon recurrent neural networks and image processing, such that the model may process full-length documents and/or documents of varying types. Moreover, the IA server is configured to implement the latest machine learning and computer vision techniques to achieve more accurate OCR performance on full documents, provide statistical analysis of and insights, and leverage claim-specific document layouts and text corpus to tailor outputs to claims-specific use.

By automating the claims processing workflow, which is error-prone, laborious, and inefficient, the IA server facilitates reducing processing time, reducing processing errors, increasing claims throughput, enabling aggregated insights (e.g., fraud and trend analysis), and improving customer experience. That is, by utilizing machine learning models and/or algorithms, the IA server is able to streamline and enhance the document classification and analysis process by enabling a greater volume and type (e.g., high-resolution and low-resolution image data) of image data to be accurately classified and processed (e.g., identifying and verifying document content therein).

At least one of the technical problems addressed by this system includes automating a claim document classification and analysis process that was previously, from start to finish, performed by hand. More specifically, the systems, methods, and computer-readable media described herein provide an efficient and reliable document classification and analysis process that utilizes artificial intelligence techniques to build a classification model, build a verification model, and implement the verification model to determine whether document content is verified or unverified.

Exemplary technical effects of the systems, methods, and computer-readable media described herein may include, for example: (i) improved ability to accurately process and analyze a large volume of image data associated with submitted claim documents; (ii) reduced time and effort required to correctly classify and/or analyze submitted claim documents; (iii) improved speed in generating, processing, and/or issuing claims and/or claim disbursements after an insurance claim event; (iv) improved efficiency and accuracy in assessing submitted documents for fraud; and/or (v) improved ability to track and monitor the lifecycle of a claim.

The methods and systems described herein may be implemented using computer programming or engineering techniques including computer software, firmware, hardware, or any combination or subset thereof, wherein the technical effects may be achieved by performing at least one of the following: (a) receiving, from a user computing device associated with an insurance policyholder, an insurance claim request including (i) image data representing a document associated with an insurance claim, and (ii) an identifier of the insurance claim; (b) executing an extraction module to extract document content of the document from the image data; (c) executing a classification module to classify the document as one document type of a plurality of document types, wherein the classification module applies a document classification model to the extracted document content; (d) executing a content verification module to verify the extracted document content based upon the document type of the document; (e) when the extracted document content is verified: (i) applying the extracted document content to the insurance claim identified by the received identifier to update the insurance claim; (ii) transmitting an insurance claim response to the user computing device indicating the extracted document content was verified and applied to the insurance claim; and (iii) processing the updated insurance claim; and (f) when the extracted document content is not verified: (i) updating the insurance claim identified by the received identifier with a denial indicator; and (ii) transmitting an insurance claim response to the user computing device indicating the insurance claim is denied based upon the extracted document content not being verified.

### Exemplary System for Classifying and Analyzing Insurance Claim Documents

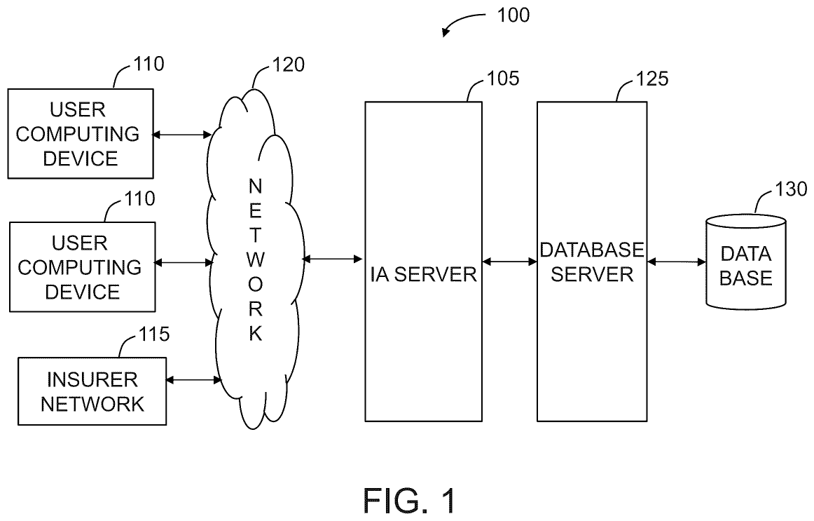

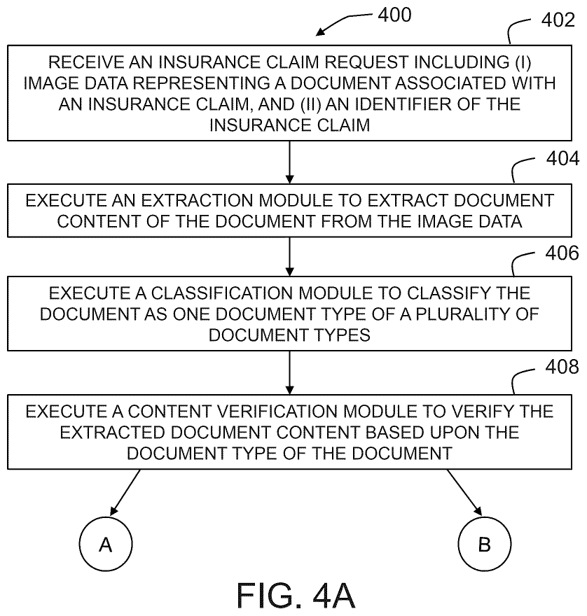

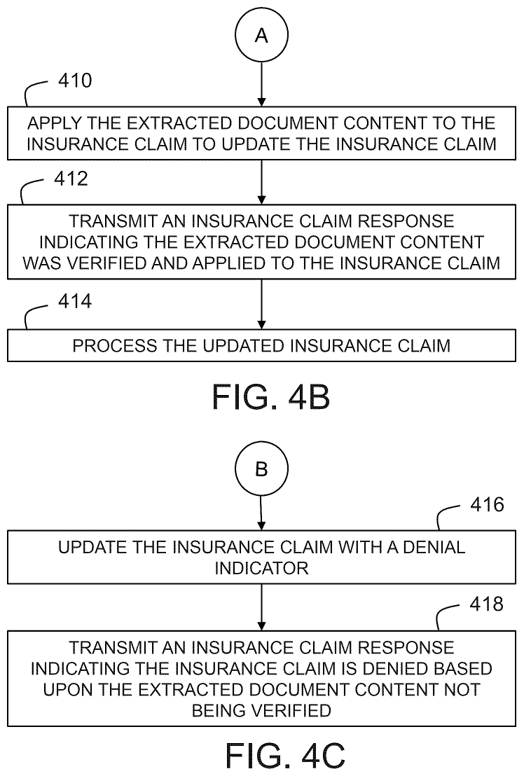

FIG. 1 depicts a view of an exemplary embodiment of an image analysis (IA) computer system 100 for document classification and analysis using artificial intelligence and machine learning techniques. IA computer system 100 includes computing devices that are capable of implementing process 400 shown in FIGS. 4A-4C. In the exemplary embodiment, IA computer system 100 includes an image analysis (IA) server 105, and may be used for at least partially automating insurance claims processing by automatically classifying and analyzing documents submitted for an insurance claim.

As described below in more detail, IA server 105 is a non-conventional computing device configured to at least: (a) receive, from a user computing device associated with an insurance policyholder, an insurance claim request including (i) image data representing a document associated with an insurance claim, and (ii) an identifier of the insurance claim; (b) execute an extraction module to extract document content of the document from the image data; (c) execute a classification module to classify the document as one document type of a plurality of document types, wherein the classification module applies a document classification model to the extracted document content; (d) execute a content verification module to verify the extracted document content based upon the document type of the document; (e) when the extracted document content is verified: (i) apply the extracted document content to the insurance claim identified by the received identifier to update the insurance claim; (ii) transmit an insurance claim response to the user computing device indicating the extracted document content was verified and applied to the insurance claim; and (iii) process the updated insurance claim; and (f) when the extracted document content is not verified: (i) update the insurance claim identified by the received identifier with a denial indicator; and (ii) transmit an insurance claim response to the user computing device indicating the insurance claim is denied based upon the extracted document content not being verified.

In the exemplary embodiment, IA computer system 100 includes at least one user computing device, such as user computing devices 110. User computing devices 110 may be associated with users, such as policyholders and/or human claims or data analysts. In addition to IA server 105 and user computing devices 110, IA computer system 100 may also include an insurer network 115, a network 120, a database server 125, and a database 130. In the exemplary embodiment, user computing devices 110 are computers that include a web browser or a software application, which enables user computing devices 110 to access remote servers, such as IA server 105 and/or insurer network 115 computing devices, using network 120, the Internet, or other network. More specifically, user computing devices 110 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computing devices 110 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. User computing devices 110 may be any personal computing device and/or any mobile communications device of a user, such as a personal computer, a tablet computer, a smartphone, and the like. User computing devices 110 may be configured to present an application (e.g., a smartphone “app”) or a webpage, such as a webpage or an app for submitting documents associated with an insurance claim, viewing progress of the insurance claim, and the like. To this end, user computing devices 110 may include or execute software, such as a web browser, for viewing and interacting with a webpage and/or an app. Although two user computing devices 110 are shown in FIG. 1 for clarity, it should be understood that IA computer system 100 may include any number of user computing devices 110.

Insurer network 115 computing devices include one or more computing devices associated with an insurance provider. In the exemplary embodiment, the insurance provider is associated with one or more insurance policies, which are in turn each associated with a respective policyholder. In the exemplary embodiment, insurance network 115 computing devices include a web browser or a software application, which enables insurance network 115 computing devices to access remote servers, such as IA server 105 and database server 125, using network 120. More specifically, insurance network 115 computing devices may be communicatively coupled to network 120 through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

Insurance network 115 computing devices may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, insurance network 115 computing devices may access database 130 to review submitted documents associated with an insurance claim, review analytics associated with the submitted documents, review trend analyses, update analysis models, determine the status of an in-progress insurance claim, review reimbursement information, and the like.

Network 120 may be any electronic communications system, such as any computer network or collection of computer networks, and may incorporate various hardware and/or software. Communication over network 120 may be accomplished via wired communication, or wireless communication or data transmission over one or more radio frequency links or communication channels. For instance, communication over network 120 may be accomplished via any suitable communication channels, such as, for example, one or more telephone networks, one or more extranets, one or more intranets, the Internet, one or more point of interaction devices (e.g., one or more interaction devices, smart phones or mobile devices, cellular phones), various online and/or offline communications systems, such as various local area and wide area networks, and the like.

IA server 105 is configured to communicate with a user computing device 110 associated with a user (not shown). User computing device 110 may be a web server, such as a computer or computer system that is configured to receive and process requests made via HTTP. In some embodiments, IA server 105 is also configured to receive and process requests made via HTTPS. IA server 105 may be coupled between user computing devices 110 and database server 125. More particularly, IA server 105 may be communicatively coupled to user computing devices 110 via network 120.

In various embodiments, IA server 105 may be directly coupled to database server 125 and/or communicatively coupled to database server 125 via a network, such as network 120. IA server 105 may, in addition, function to store, process, and/or deliver one or more web pages and/or any other suitable content to user computing devices 110. IA server 105 may, in addition, receive data, such as data provided to the app and/or webpage (as described herein) from user computing devices 110 for subsequent transmission to database server 125.

In some embodiments, IA server 105 may be associated with, or is part of a computer network associated with an insurance provider, or in communication with insurer network 115 computing devices. In other embodiments, IA server 105 may be associated with a third party and is merely in communication with insurer network 115 computing devices.

In various embodiments, IA server 105 may implement various hardware and/or software, such as, for example, one or more communication protocols, one or more message brokers, one or more data processing engines, one or more servlets, one or more application servers, and the like. In various embodiments, IA server 105 may implement a message broker program module configured to translate a message or communications from a messaging protocol of a sending device to a messaging protocol of a receiving device (e.g., RABBITTMQ, KAFKA, ACTIVEMQ, KESTREL). Further still, in some embodiments, IA server 105 may implement a data processing engine, such as a cluster computing framework like APACHE SPARK. In addition, in various embodiments, IA server 105 may implement servlet and/or JSP server, such as APACHE TOMCAT.

Database server 125 may be any computer or computer program that provides database services to one or more other computers or computer programs. In various embodiments, database server 125 may be communicatively coupled between web server 125 and database 130. Database server 125 may, in addition, function to process data received from IA server 105.

Database 130 may be any organized collection of data, such as, for example, any data organized as part of a relational data structure, any data organized as part of a flat file, and the like. Database 130 may be communicatively coupled to database server 125 and may receive data from, and provide data to, database server 125, such as in response to one or more requests for data, which may be provided via a database management system (DBMS) implemented on database server 125, such as SQLite, PostgreSQL (e.g., Postgres), or MySQL DBMS. Database 130 may be a scalable storage system that includes fault tolerance and fault compensation capabilities. Data security capabilities may also be integrated into database 130. In one embodiment, database 130 may be Hadoop® Distributed File System (HDFS). In other embodiments, database 130 may be a non-relational database, such as APACHE Hadoop® database.

In the exemplary embodiment, database 130 may include various data, such as historical claims information (including submitted documents, document content associated therewith, claim results such as approval or denial, reimbursement amounts, and the like), in-progress claims information, training data sets, and various document analysis models, as described in further detail herein. In the exemplary embodiment, database 130 may be stored remotely from IA server 105. In some embodiments, database 130 may be decentralized. In the exemplary embodiment, a user (e.g., a claims analyst or administrator) may access database 130 via user computing devices 110 and/or insurance network 115 computing devices by logging onto IA server 105, as described herein.

In the example embodiment, each user computing device 110 includes a user interface (not shown). For example, the user interface may include a graphical user interface with interactive functionality, such that the user thereof (e.g., a policyholder) may submit documents and review the status of in-progress insurance claims. In the example embodiment, a web portal is hosted by or stored on IA server 105 and accessed by user computing device 110 to display the graphical user interface. For example, the web portal may be stored on and executed by IA server 105.

User computing device 110 may provide inputs to the web portal. The inputs are received by IA server 105 via network 120 and are used by IA server 105 to execute functions as described above. The web portal may further provide outputs to user computing device 110. The web portal may be a website (e.g., hosted by IA server 105), application, or other tool.

In further embodiments, a user such as a policyholder may access the web portal hosted by IA server 105 to, among other things, submit documents to IA server 105, receive and review the results of any analysis by IA server 105, review claim status, and the like. In additional embodiments, an administrator or claims analyst may access the web portal hosted by IA server 105 to, among other things, review verification results from IA server 105, request or review trend analyses, review claim status, and the like.

Although the components of system 100 are described below and depicted at FIG. 1 as being interconnected in a particular configuration, it is contemplated that the systems, subsystems, hardware and software components, various network components, and database systems described herein may be variously configured and interconnected and may communicate with one another within IA computer system 100 to facilitate the processes and advantages described herein. For example, although a single insurer network 115, a single network 120, a single database server 125, and a single database 130 are described above, it will be appreciated that system 100 may include any suitable number of interconnected, communicatively coupled, user computing devices, networks, servers, and/or databases. Further, although certain functions, processes, and operations are described herein with respect to one or more system components, it is contemplated that one or more other system components may perform the functions, processes, and operations described herein.

### Exemplary Client Device

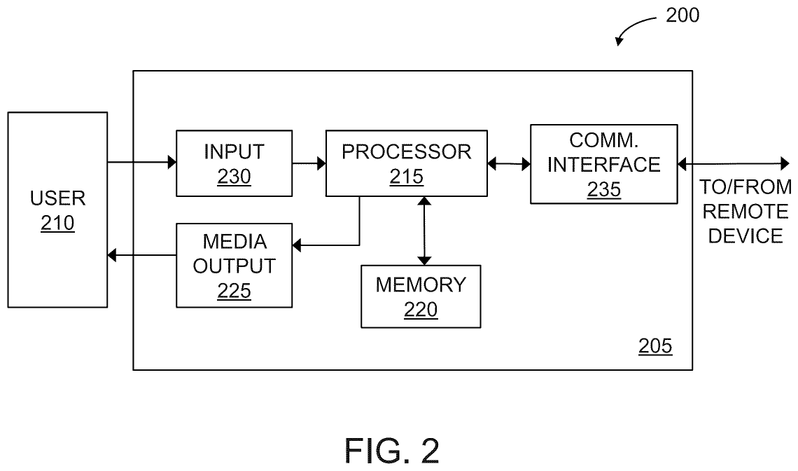

FIG. 2 depicts an exemplary configuration 200 of a user computing device 205, in accordance with one embodiment of the present disclosure. In the exemplary embodiment, user computing device 205 may be similar to, or the same as, user computing devices 110 (shown in FIG. 1). User computing device 205 may be operated by a user 210. User computing device 205 may include, but is not limited to, user computing devices 110 and insurer network 115 computing devices (both shown in FIG. 1). User computing device 205 may include a processor 215 for executing instructions. In some embodiments, executable instructions may be stored in a memory area 220. Processor 215 may include one or more processing units (e.g., in a multi-core configuration).

Memory area 220 may be any device allowing information such as executable instructions and/or image data to be stored and retrieved. Memory area 220 may include one or more computer readable media.

User computing device 205 may also include at least one media output component 225 for presenting information to user 210. Media output component 225 may be any component capable of conveying information to user 210. In some embodiments, media output component 225 may include an output adapter (not shown) such as a video adapter and/or an audio adapter. An output adapter may be operatively coupled to processor 215 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 225 may be configured to present a graphical user interface (e.g., a web browser and/or a client application) to user 210. A graphical user interface may include, for example, a user interface for logging into IA server 105, submitting insurance claim documents, and reviewing claim responses and/or progress. The graphical user interface may also include, for example, an administrator user interface for viewing analytics associated with classified documents, including the results of verification processes described herein, and for approving or denying insurance claims based thereon.

In some embodiments, user computing device 205 may include an input device 230 for receiving input from user 210. User 210 may use input device 230 to, without limitation, submit insurance claim documents, review claim responses and/or progress, view analytics, approve/deny insurance claims, and the like.

Input device 230 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 225 and input device 230.

User computing device 205 may also include a communication interface 235, communicatively coupled to a remote device such as IA server 105 (shown in FIG. 1). Communication interface 235 may include, for example, a wired or wireless network adapter and/or a wireless data transceiver for use with a mobile telecommunications network.

Stored in memory area 220 are, for example, computer readable instructions for providing a user interface to user 210 via media output component 225 and, optionally, receiving and processing input from input device 230. A user interface may include, among other possibilities, a web browser and/or a client application. Web browsers enable users, such as user 210, to display and interact with media and other information typically embedded on a web page or a website from IA server 105. An end user program, such as a client application may allow user 210 to interact with, for example, IA server 105. For example, instructions may be stored by a cloud service, and the output of the execution of the instructions sent to the media output component 225.

Processor 215 executes computer-executable instructions for implementing aspects of the disclosure. In some embodiments, processor 215 is transformed into a special purpose microprocessor by executing computer-executable instructions or by otherwise being programmed.

### Exemplary Server Device

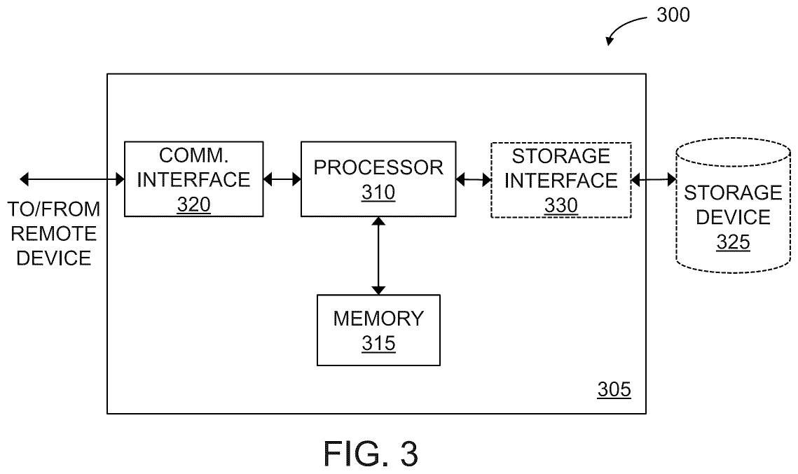

FIG. 3 depicts an exemplary configuration 300 of a server computing device 305, in accordance with one embodiment of the present disclosure. In the exemplary embodiment, server computing device 305 may be similar to, or the same as, IA server 105 (shown in FIG. 1). Server computing device 305 may include, but is not limited to, IA server 105, insurer network 115 computing devices, database server 125, and database 130 (all shown in FIG. 1). Server computing device 305 may also include a processor 310 for executing instructions. Instructions may be stored in a memory area 315. Processor 310 may include one or more processing units (e.g., in a multi-core configuration). The instructions may be executed within a variety of different operating systems on server computing device 305, such as UNIX, LINUX, Microsoft Windows®, etc.

It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, or other suitable programming languages, etc.).

Processor 310 may be operatively coupled to a communication interface 320 such that server computing device 305 is capable of communicating with a remote device such as another server computing device 305, IA server 105, insurance network 115 computing devices, user computing devices 110, and/or database server 135 (all shown in FIG. 1). For example, communication interface 320 may receive requests from user computing devices 110 via the Internet, as illustrated in FIG. 1.

Processor 310 may also be operatively coupled to a storage device 325. Storage device 325 may be any computer-operated hardware suitable for storing and/or retrieving data, such as, but not limited to, data associated with database 130 (shown in FIG. 1). In some embodiments, storage device 325 may be integrated in server computing device 305. For example, server computing device 305 may include one or more hard disk drives as storage device 325. In other embodiments, storage device 325 may be external to server computing device 305 and may be accessed by a plurality of server computing devices 305. For example, storage device 325 may include a storage area network (SAN), a network attached storage (NAS) system, and/or multiple storage units such as hard disks and/or solid state disks in a redundant array of inexpensive disks (RAID) configuration.

In some embodiments, processor 310 may be operatively coupled to storage device 325 via a storage interface 330. Storage interface 330 may be any component capable of providing processor 310 with access to storage device 325. Storage interface 330 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 310 with access to storage device 325.

Processor 310 may execute computer-executable instructions for implementing aspects of the disclosure. In some embodiments, the processor 310 may be transformed into a special purpose microprocessor by executing computer-executable instructions or by otherwise being programmed. For example, the processor 310 may be programmed with instructions, such as illustrated in FIGS. 4A-4C.

Memory area 315 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Computer-Implemented Method for Document Classification and Analysis

FIGS. 4A-4C illustrate a flowchart of an exemplary computer-implemented process 400 implemented by IA computer system 100 (shown in FIG. 1) for classifying and analyzing documents associated with insurance claims. Process 400 may be implemented by a computing device, for example IA computer system 100 (shown in FIG. 1). In the exemplary embodiment, IA computer system 100 includes IA server 105, user computing devices 110, insurer network 115 computing devices, database server 125, and/or database 130 (all shown in FIG. 1).

In the exemplary embodiment, process 400 may include IA server 105 receiving 402 an insurance claim request including (i) image data representing a document associated with an insurance claim, and (ii) an identifier of the insurance claim. IA server 405 may receive 402 the insurance claim from a user computing device (e.g., user computing device 110) associated with an insurance policyholder.

Process 400 may also include IA server 105 executing 404 an extraction module to extract document content (e.g., at least one of document text and document images) of the document from the image data, and executing 406 a classification module to classify the document as one document type of a plurality of document types. In the exemplary embodiment, the classification module applies a document classification model to the extracted document content to classify the document as the document type. The document classification model may utilize one or more artificial intelligence algorithms, including machine learning techniques for analyzing document content to classify documents.

In addition, process 400 may include executing 408 a content verification module to verify the extracted document content based upon the document type of the document. The content verification module may employ one or more artificial intelligence algorithms, including machine learning techniques for comparing, validating, verifying, and/or authenticating document content (e.g., based on historical document content). As shown in FIG. 4B, when the extracted document content is verified, process 400 further includes applying 410 the extracted document content to the insurance claim identified by the received identifier to update the insurance claim, transmitting 412 an insurance claim response to the user computing device indicating the extracted document content was verified and applied to the insurance claim, and processing 414 the updated insurance claim (e.g., submitting the insurance claim for reimbursement in an amount identified in the document content),

As shown in FIG. 4C, when the extracted document content is not verified, process 400 may further include updating 416 the insurance claim identified by the received identifier with a denial indicator, and transmitting 418 an insurance claim response to the user computing device indicating the insurance claim is denied based upon the extracted document content not being verified.

### Exemplary System for Classifying and Analyzing Insurance Claim Documents

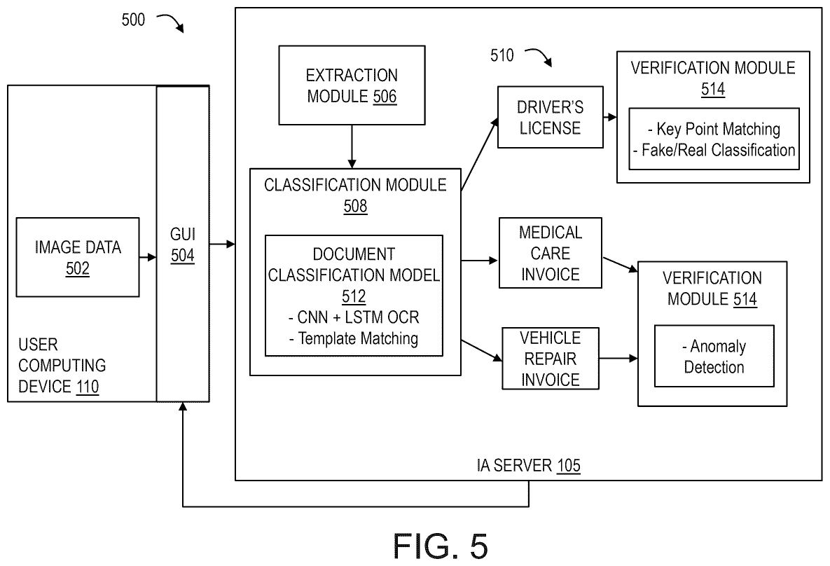

FIG. 5 illustrates a flow diagram 500 of IA computer system 100 (shown in FIG. 1) at least partially implementing process 400 shown in FIGS. 4A-4C to classify and analyze documents associated with an insurance claim in accordance with one aspect of the present disclosure. In the exemplary embodiment, process 500 is performed by one or more computing devices of the IA computer system 100, including IA server 105 and user computing device(s) 110.

In the illustrated embodiment, user computing device 110 attains image data 502 representing a document requested and/or required during processing of an insurance claim. In some embodiments, a policyholder captures an image of the document using user computing device 110, such as by taking a picture of the document using an integral camera. In other embodiments, the policyholder captures image data 502 using another image-capture device (e.g., a separate scanner, not shown) and transmits the image data to user computing device 110. The policyholder then accesses a webpage, software application, or the like, which is maintained by IA server 105 and/or insurance network 115 (shown in FIG. 1) and enables the policyholder to access the functionality of IA server 105. In the exemplary embodiment, upon accessing the webpage or application, the webpage or application displays a graphical user interface (GUI) 504. The policyholder interacts with GUI 504 to submit or upload image data 502.

Upon upload by the policyholder, IA server 105 receives image data 502. As described herein, IA server 105 is configured to process image data 502 to classify the represented document as one of a plurality of document types and to verify the content of the represented document. To implement these processes, IA server 105 executes one or more modules using a processing component (e.g., a processor 310). The one or modules may include specialized instruction sets or kernel extensions that, upon execution by the processor, cause the processor to perform the functions described herein. The modules may additionally or alternatively include co-processors specifically programmed to perform the described functions.

IA server 105 may initially execute an extraction module 506 to extract document content from image data 502. As used herein, “document content” may include at least one of document text and document images from the represented document. Content extraction module may include, for example, image processing functionality that identifies text and/or images within image data 502 and extracts the text and/or images as analyzable data sets (i.e., the document content). Document content may include the actual content (e.g., images and/or texts) as well as characteristics thereof, such as placement, size/scale, formatting, and the like. For instance, document content may include an image as well as data indicating that the image is a particular size and located on a left-hand side of the document.

IA server 105 is further configured to execute a classification module 508 to classify the document as one document type of a plurality of document types 510. In one exemplary embodiment, classification module 508 applies a document classification model 512 to the extracted document content. In some embodiments, document classification model 512 includes at least one of a conditional neural network (CNN) optical character recognition (OCR) model, a long short term memory (LSTM) OCR model, and a template matching model. In some embodiments, document classification model 512 is built based upon training data sets of document content of historical and/or example documents of the plurality of document types, as described further herein.

In some embodiments, document classification module 508 applies document classification model 512, which outputs a confidence score representing a likelihood that the document is a particular document type 510. Moreover, document classification model 512 outputs a confidence score for the document for each of the plurality of document types 510. Document classification module 508 orders the confidence scores, for example, from lowest to highest or highest to lowest. Document classification module 508 subsequently classifies the document as one of the document types 510 based upon the highest output confidence score.

Based upon the document type 510 of the document, as identified by document classification module 508, IA server 105 is further configured to execute a content verification module 514 to verify the extracted document content. As used herein, “verification” refers to determining if the document content (and, therefore, the document from which the document content is extracted) is (i) associated with the policyholder, (ii) real (i.e., not forged or otherwise fake), and/or (iii) appropriate to the associated insurance claim. For example, “verification” of a vehicle repair invoice may include determining whether a charged or estimated amount for a particular repair service (e.g., taillight replacement) is appropriate.

“Appropriate,” as used herein, refers to a value within a predetermined range including an average and/or median amount, such as within two standards of deviation of the median/average amount for a service or within a predefined percentage of the median/average amount (e.g., within 50% of the median/average amount). In some embodiments, the predetermined range may be more limited with respect to values above the median/average amount than with respect to values below the median/average amount. For example, the predetermined range may be defined as zero to no more than 40% above the median/average amount, such that any amount below the median/average amount is considered appropriate. If an “inappropriate” amount, which is an outlier and falls outside of the predetermined range, is charged for a service, a vehicle repair invoice including the inappropriate amount is considered “unverified,” in the context of the present disclosure. In this way, fraudulent or excessive charges from a service provider may be declined by the insurer.

In the exemplary embodiment, where the document is classified as a driver's license (i.e., the document type 510 of the document is “driver's license”), executing content verification module 514 may include performing at least one of (a) key point matching based upon the extracted document content and stored data associated with the policyholder (e.g., matching between image data 502 representing the driver's license and stored image data representing the driver's license), and (b) fake/real classification. If the key point matching is successful (e.g., image data 502 matches the stored image data), the document content is verified. If the key point matching is unsuccessful (e.g., image data 502 does not match the stored image data), the document content is not verified. Likewise, if the outcome of the fake/real classification is that the driver's license represented in image data 502 is real, the document content is verified. If the outcome of the fake/real classification is that the driver's license represented in image data 502 is not real (e.g., is likely fake), the document content is not verified.

In another example, where the document is classified as a vehicle repair invoice (i.e., the document type 510 of the document is “vehicle repair invoice”), executing content verification module 514 may include performing anomaly detection based upon the extracted document content and stored historical vehicle repair invoice data, as described further herein, to determine if charge(s) for at least one vehicle repair service are appropriate. If all charges associated with all at least one vehicle repair services identified in the document are determined to be appropriate, the document content is verified. In some embodiments, if one or more charge(s) is inappropriate, the document content is not verified.

Likewise, in cases where the document is classified as a medical care invoice (i.e., the document type 510 of the document is “medical care invoice”), executing content verification module 514 may include performing anomaly detection based upon the extracted document content and stored historical medical care invoice data, as described further herein, to determine if charge(s) for at least one medical care service are appropriate. If all charges associated with all at least one medical care services identified in the document are determined to be appropriate, the document content is verified. In some embodiments, if one or more charge(s) is inappropriate, the document content is not verified.

IA server 105 is configured to transmit a response back to user computing device 110 for display to the policyholder within GUI 504. The response includes an indicator of the outcome of the content verification and a status of the associated insurance claim (e.g., approved, denied, provisionally denied, provisionally approved, etc.).

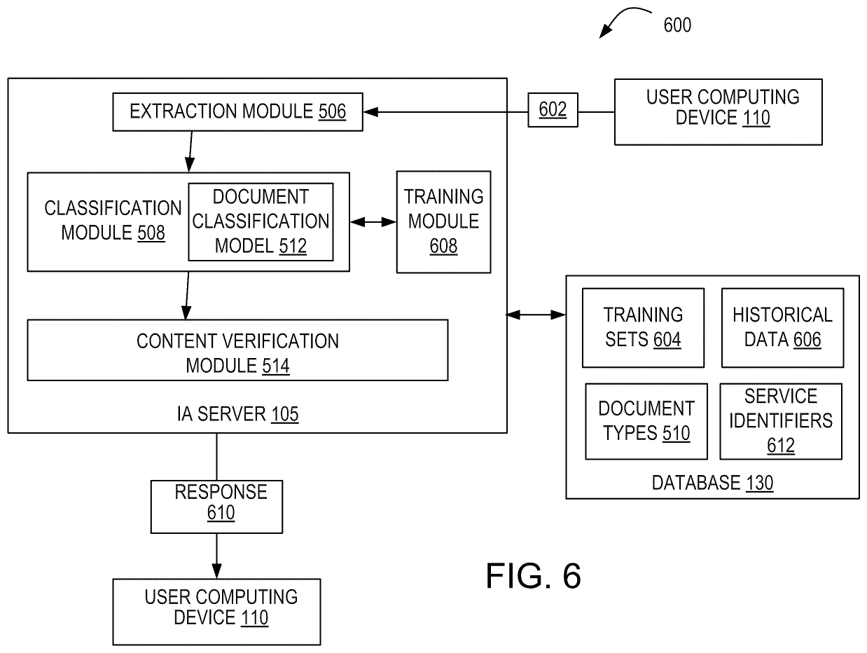

FIG. 6 illustrates a schematic diagram 600 of IA computer system 100 shown in FIG. 1 implementing the process shown in FIGS. 4A-4C. As described herein, in the exemplary embodiment, IA server 105 is configured to receive an insurance claim request 602 from the policyholder, specifically from user computing device 110 of the policyholder. Insurance claim request 602 is associated with an existing insurance claim and, as such, includes an identifier of the insurance claim. Insurance claim request 602 further includes image data 502 (shown in FIG. 5) representing a document associated with the insurance claim. The document may be, for example, a driver's license (or other identification), a vehicle repair invoice, or a medical care invoice. In other examples, the document may include any document that may be requested and/or required during processing of an insurance claim, such as a police report, a medical evaluation, images depicting “before and after” status of an insured item, and/or the like.

Initially, the IA server is configured to classify the document, or to identify what type of document is represented in the received image data. In one exemplary embodiment, the IA server is configured to classify the document as one document type of a plurality of document types 510. In one particular embodiment, document types 510 are driver's license, vehicle repair invoice, and medical care invoice. As described above, however, document types 510 may include any number of additional and/or alternative document types. Indications and/or definitions of document types 510 may be saved in database 130 and accessed by classification module 508. Accordingly, new document types 510 may be added to database 130 to update classification module 508.

To classify the document, as described herein, IA server 105 may initially execute extraction module 506 to extract document content from image data 502. IA server 105 is further configured to execute classification module 508 to classify the document as one document type 510. In some embodiments, document classification model 512, implemented by classification module 508, is built based upon training data sets 604 of document content of historical and/or example documents of the plurality of document types 510.

For example, database 130 may include a training set 604 of driver's license document content. Training set 604 of driver's license document content may include historical driver's license document content (e.g., historical data 606), or driver's license data that has been submitted to IA server 105 in one or more historical insurance claims. Additionally or alternatively, training set 604 of driver's license document content may include example driver's license document content that is not associated with any real driver's licenses but is instead representative of “typical” driver's license document content, such as sample names, alphanumeric driver's license identifiers, sample addresses, sample images, and the like. IA server 105 may execute a training module 608 to train classification module 508 based upon training set 604 of driver's license document content, and may build document classification model 512 based on the training.

Additionally or alternatively, database 130 may store a training set 604 of vehicle repair invoice document content. Training set 604 of vehicle repair invoice document content may include historical vehicle repair invoice document content (e.g., historical data 606), or vehicle repair invoice data that has been submitted to IA server 105 in one or more historical insurance claims. Additionally or alternatively, training set 604 of vehicle repair invoice document content may include example vehicle repair invoice document content that is not associated with any real vehicle repair invoices but is instead representative of “typical” vehicle repair invoice document content, such as sample names, sample repair or maintenance services, associated numeric costs, and the like. IA server 105 may execute training module 608 to train classification module 508 based upon training set 604 of vehicle repair invoice document content, and may build document classification model 512 based on the training.

Additionally or alternatively, database 130 may store a training set 604 of medical care invoice document content. Training set 604 of medical care invoice document content may include historical medical care invoice document content (e.g., historical data 606), or medical care invoice data that has been submitted to IA server 105 in one or more historical insurance claims. Additionally or alternatively, training set 604 of medical care invoice document content may include example medical care invoice document content that is not associated with any real medical care invoices but is instead representative of “typical” medical care invoice document content, such as sample names, sample medical care services, associated numeric costs, and the like. IA server 150 may execute training module 608 to train classification module 508 based upon training set 604 of medical care invoice document content, and may build document classification model 512 based on the training.

When document content for an insurance claim is verified according to the processes described herein, IA server 104 may store the verified document content as parts of trainings sets 604, such that verified document content may be used to continuously update and refine document classification model 512.

Based upon the document type 510 of the document, as identified by document classification module 508, IA server 105 is further configured to execute content verification module 514 to verify the extracted document content. As described above, where the document is classified as a driver's license (i.e., the document type 510 of the document is “driver's license”), executing content verification module 514 may include performing at least one of (a) key point matching based upon the extracted document content and stored data associated with the policyholder (e.g., matching between the received image data representing the driver's license and stored image data representing the driver's license), and (b) fake/real classification.

Where the document is classified as a vehicle repair invoice (i.e., the document type 510 of the document is “vehicle repair invoice”), executing content verification module 514 may include performing anomaly detection based upon the extracted document content and stored historical vehicle repair invoice data 606. In such examples, content verification module 514 determines, from the extracted document content, at least one vehicle repair service identified by the document and an associated charge for each at least one vehicle repair service (also identified by the document). Content verification module 514 retrieves stored historical vehicle repair invoice data 606 including historical vehicle repair services and associated charges from database 130. Content verification module 514 determines an average or median charge for each at least one vehicle repair service identified by the document, and also determines whether the associated charge, as identified by the document, is appropriate (e.g., within a predetermined range of the median/average charge). If all charges associated with all at least one vehicle repair services identified in the document are determined to be appropriate, the document content is verified. In some embodiments, if one or more charge(s) is inappropriate, the document content is not verified.

In some embodiments, IA server 105 additionally or alternatively uses historical data 606 to identify common or typical vehicle repair services associated with similar insurance claims. For example, the pending insurance claim is associated with a rear-end accident. Content verification module 514 retrieves historical data 606 associated with other rear-end accidents and extracts information therefrom, specifically vehicle repair services rendered. Content verification module 514 compares the one or more vehicle repair services identified by the document to the historical vehicle repair services to determine whether the one or more vehicle repair services is common or expected (e.g., occurs in a threshold number or percentage of claims). For example, a taillight repair service may be common or expected, and therefore such a vehicle repair service is verified. However, a front windshield repair service may be neither common nor expected (e.g., may not occur in any historical vehicle repair claims or may occur a number of times below a predetermined threshold), and such a vehicle repair service may not be verified.

Where the document is classified as a medical care invoice (i.e., the document type 510 of the document is “medical care invoice”), executing content verification module 514 may include performing anomaly detection based upon the extracted document content and stored historical medical care invoice data 606. In such examples, content verification module 514 determines, from the extracted document content, at least one medical care service identified by the document and an associated charge for each at least one medical care service (also identified by the document). Content verification module 514 retrieves stored historical medical care invoice data 606 including historical medical care services and associated charges from database 130. Content verification module 514 determines an average or median charge for each at least one medical care service identified by the document, and also determines whether the associated charge, as identified by the document, is appropriate (e.g., within a predetermined range of the median/average charge). If all charges associated with all at least one medical care services identified in the document are determined to be appropriate, the document content is verified. In some embodiments, if one or more charge(s) is inappropriate, the document content is not verified.

In some embodiments, IA server 105 additionally or alternatively uses historical data 606 to identify common or typical medical care services associated with similar insurance claims. For example, the pending insurance claim is associated with a rear-end accident. Content verification module 514 retrieves historical data 606 associated with other rear-end accidents and extracts information therefrom, specifically medical care services rendered. Content verification module 514 compares the one or more medical care services identified by the document to the historical medical care services to determine whether the one or more medical care services is common or expected (e.g., occurs in a threshold number or percentage of claims). For example, medical care for a concussion or whiplash may be common or expected, and therefore such a medical care service is verified. However, other medical care services may be neither common nor expected (e.g., may not occur in any historical vehicle repair claims or may occur a number of times below a predetermined threshold), and as such may not be verified.

In some embodiments, database 130 stores a list, table, or other data structure including service identifiers 612, such as medical billing codes. Accordingly, content verification module 514 may access database 130 when processing the document content to compare service identifiers in the document content with stored service identifiers 612, to thereby identify the particular service, such as a medical service, that is part of insurance claim request 602.

In some embodiments, IA server 105 identifies a subset of historical data 606 with one or more characteristics matching or similar to characteristics of the document being analyzed, such as historical data 606 associated with insurance claims in the same geographical area and/or associated with services offered by the same vendor(s). IA server 105 may conduct the above-described verification processes using the subset of historical data 606, which may provide a more precise range of appropriate charges for various services. For example, certain vehicle repair or medical care services may be more expensive in remote locations. Where document content is associated with a particular remote location, by verifying document content using the subset of historical data 606 from that remote location (or similar locations), IA server 105 may be more likely to properly verify document content that otherwise may appear inappropriate (e.g., appear too expensive).

When document content for an insurance claim is verified according to the processes described herein, IA server 104 may store the verified document content as historical data 606, such that verified document content may be used to continuously update and refine the models and/or processes (e.g., anomaly detection) implemented by content verification module 514.

When the extracted document content is verified, IA server 105 transmits an insurance claim response 610 to user computing device 110, wherein insurance claim response 610 includes an indicator that insurance claim request 602 was approved. IA server 105 is also configured to apply the document content to the associated insurance claim. For example, IA server 105 may process the insurance claim and/or initiate reimbursement to the policyholder of an amount equal to a total of all appropriate charges.

When the extracted content is not verified, IA server 105 transmits insurance claim response 610 including an indicator that insurance claim request 602 was denied. IA server 105 may also update the associated insurance claim with an indicator that unverified content was provided by the policyholder.

In at least some embodiments, IA server 105 is further configured to use the image data representing the document submitted and analyzed as described above to perform trend analysis and/or claims processing predictions. More particularly, IA server 105 is configured to leverage historical claims data (e.g., historical data 606) and the data associated with the insurance claim request (e.g., the claim identifier, the document content as classified and/or verified, etc.) to identify and/or analyze overall trends in insurance claims and to provide information to a policyholder and/or claim analyst about the lifecycle of the individual insurance claim. Where IA server 105 performs such trend analysis, IA server 105 may store the results of the analysis in database 130, for example as historical data 606 and/or as part of training data sets 604, for use as model feedback. For example, where trend analysis indicates that charges for particular medical care services are rising year over year, IA server 104 may use this information update its internal verification models to expand the range of appropriate charges for that service.

### Exemplary User Interfaces

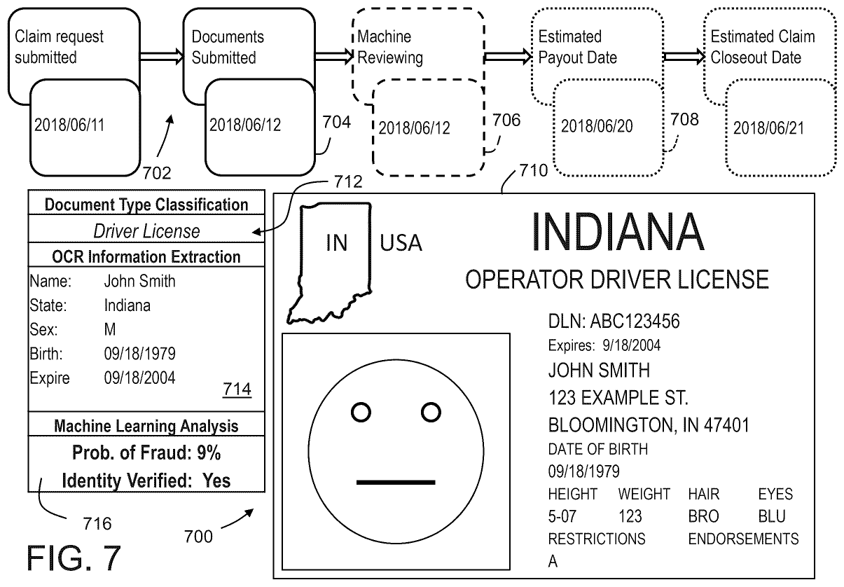

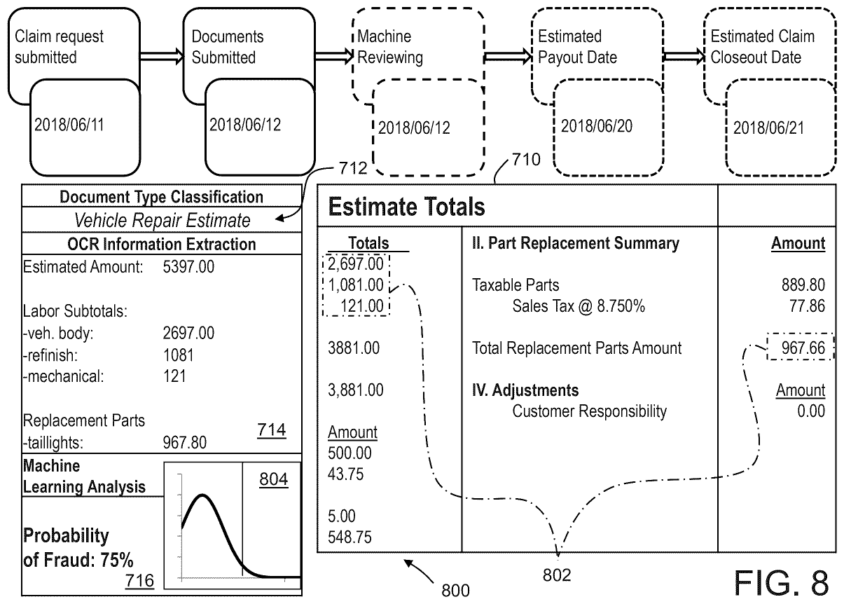

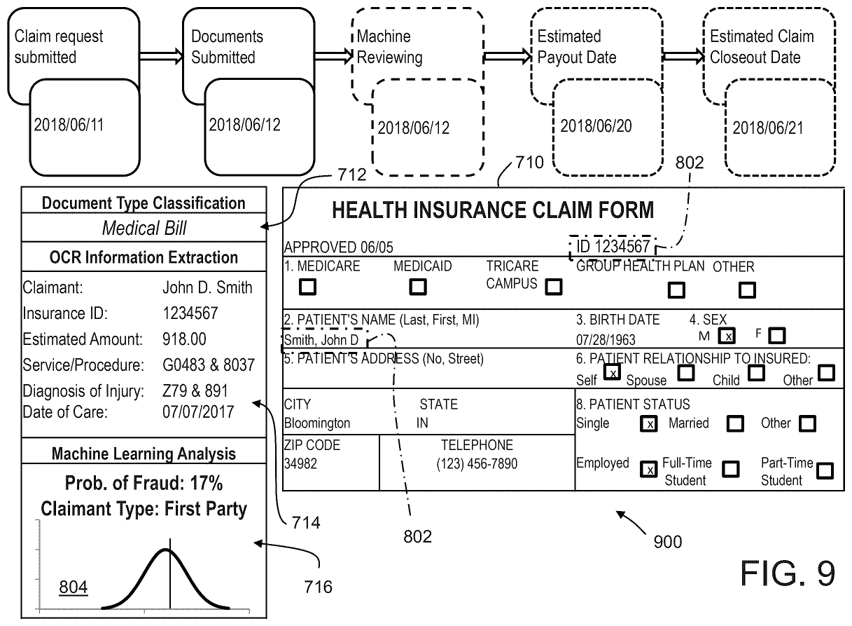

FIGS. 7-9 illustrate exemplary screenshots displayed on a user interface (not shown) of a user computing device (similar to user computing device 110 shown in FIG. 1) associated with a claims analyst and/or a policyholder. In particular, FIG. 7 illustrates an example screenshot 700 of a claim processing screen from IA server 105 depicting classifying and verifying a driver's license document, FIG. 8 illustrates an example screenshot 800 of a claim processing screen from IA server 105 depicting classifying and verifying a vehicle repair invoice document, and FIG. 9 illustrates an example screenshot 900 of a claim processing screen from IA server 105 depicting classifying and verifying a medical care invoice document.

As shown in FIGS. 7-9, IA server 105 provides, in the graphical user interface, a claim timeline 702 depicting a status of an ongoing or pending insurance claim. Claim timeline 702 includes a plurality of progress indicators 704 that identify a step in processing the insurance claim and a date at which the step has been completed or is estimated to be completed. In FIGS. 7-9, a dashed progress indicator 706 identifies a current step, and dotted indicators 708 identify future steps. IA server 105 may leverage historical claim data (e.g., historical data 606, shown in FIG. 6) to predict future steps and completion dates to display therewith. In the illustrated embodiment, “machine reviewing” is highlighted in dashed progress indicator 706 as the current step, which indicates IA server 105 is performing the classification and analysis processes described herein.

Screenshot 700 includes an image view pane 710 showing an expanded view of the image data (e.g., image data 502, shown in FIG. 5) representing the document submitted by the policyholder. The user interface may include one or more controls (not shown) that, upon manipulation by a user, enable the user to control the view within image view pane 710, such as zooming, panning, and the line. In the illustrated embodiment, the image data in image view pane 710 is an expanded view of a submitted driver's license document. A document classifier 712 identifies the document as a driver's license, based upon the output from document classification module 508 (see FIGS. 5 and 6). A document content pane 714 depicts extracted document content—in this case, document content extracted from the driver's license, for example, using an OCR model or function.

Screenshot 700 also depicts a verification result pane 716, which includes the output from content verification module 514. In this particular example, verification result pane 716 indicates that content verification module 514 determined there was a low (e.g., 9%) probability of fraud and, as such, verified the driver's license.

Turning to FIG. 8, in screenshot 800, the image data in image view pane 710 is an expanded view of a submitted vehicle repair invoice document. Document classifier 712 identifies the document as a vehicle repair invoice, based upon the output from document classification module 508. Document content pane 714 depicts extracted document content—in this case, document content extracted from the vehicle repair invoice, for example, using an OCR model or function. Document content pane 714 specifically includes vehicle repair services and associated charges, as extracted from image data 502 representing the vehicle repair invoice. In image view pane 710, content highlight identifiers 802 indicate the location within the image data from which the document content shown in document content pane 714 was extracted. A user may select document content from document content pane 714 to automatically shift the image displayed in image view pane 710 to center on the associated content highlight identifier 802 (and, therefore, the content within the image data).

Screenshot 800 also depicts verification result pane 716, which includes the output from content verification module 514. In this particular example, verification result pane 716 indicates that content verification module 514 determined there was a high (e.g., 75%) probability of fraud. Verification result pane 716 also includes a graphical indicator 804 that depicts value(s) for the current or pending insurance claim relative to historical claims (e.g., based on historical data 606). In particular, the vertical line in graphical indicator 804 depicts the estimated total amount (e.g., $5,397.00) and/or one or more individual labor or part charges relative to historical charges for similar insurance claims. In this example, the estimated total amount and/or one or more individual labor or part charges are clearly much higher than average. In this example, IA server 105 may deny the associated insurance claim request.

Turning to FIG. 9, in screenshot 900, the image data in image view pane 710 is an expanded view of a submitted medical care invoice document. Document classifier 712 identifies the document as a medical care invoice, based upon the output from document classification module 508. Document content pane 714 depicts extracted document content—in this case, document content extracted from the medical care invoice, for example, using an OCR model or function. Document content pane 714 specifically includes medical care services and an associated charge, as extracted from image data 502 representing the vehicle repair invoice. In image view pane 710, content highlight identifiers 802 indicate the location within the image data from which the document content shown in document content pane 714 was extracted. A user may select document content from document content pane 714 to automatically shift the image displayed in image view pane 710 to center on the associated content highlight identifier 802 (and, therefore, the content within the image data).

Screenshot 800 also depicts verification result pane 716, which includes the output from content verification module 514. In this particular example, verification result pane 716 indicates that content verification module 514 determined there was a relatively low (e.g., 17%) probability of fraud. Verification result pane 716 also includes graphical indicator 804 that depicts value(s) for the current or pending insurance claim relative to historical claims (e.g., based on historical data 606). In particular, the vertical line in graphic indicator 804 depicts the estimated total amount (e.g., $918.00). In this example, the estimated total amount is only slightly higher than average. In this example, IA server 105 may approve the associated insurance claim request, and process the insurance claim to initiate reimbursement in the estimated total amount.

### Exemplary Embodiments & Functionality

In one aspect, an image analysis (IA) computer system for classifying and analyzing received claim documents using artificial intelligence is provided. The IA computer system includes at least one processor in communication with at least one memory device. The at least one processor is programmed to: (a) receive, from a user computing device associated with an insurance policyholder, an insurance claim request including (i) image data representing a document associated with an insurance claim, and (ii) an identifier of the insurance claim; (b) execute an extraction module to extract document content of the document from the image data; (c) execute a classification module to classify the document as one document type of a plurality of document types, wherein the classification module applies a document classification model to the extracted document content; (d) execute a content verification module to verify the extracted document content based upon the document type of the document; (e) when the extracted document content is verified: (i) apply the extracted document content to the insurance claim identified by the received identifier to update the insurance claim; (ii) transmit an insurance claim response to the user computing device indicating the extracted document content was verified and applied to the insurance claim; and (iii) process the updated insurance claim; and (f) when the extracted document content is not verified: (i) update the insurance claim identified by the received identifier with a denial indicator; and (ii) transmit an insurance claim response to the user computing device indicating the insurance claim is denied based upon the extracted document content not being verified.

A further enhancement may be where the plurality of document types include at least: (a) driver's license, (b) vehicle repair invoice, and (c) medical care invoice.

A further enhancement may be where the at least one processor is further programmed to: (a) store, in the at least one memory device, a training set of driver's license document content; (b) execute a training module to train the classification module based upon the training set of driver's license document content; and (c) build the document classification model based upon the training.

A further enhancement may be where the at least one processor is further programmed to: (a) store, in the at least one memory device, a training set of vehicle repair invoice document content; (b) execute a training module to train the classification module based upon the training set of vehicle repair invoice document content; and (c) build the document classification model based upon the training.

A further enhancement may be where the at least one processor is further programmed to: (a) store, in the at least one memory device, a training set of medical care invoice document content; (b) execute a training module to train the classification module based upon the training set of medical care invoice document content; and (c) build the document classification model based upon the training.

A further enhancement may be where the document classification model includes at least one of a conditional neural network optical character recognition (OCR) model, a long short term memory OCR model, and a template matching model.

A further enhancement may be where the document type is driver's license, and wherein executing the content verification module to verify the extracted document content includes performing at least one of (a) key point matching based upon the extracted document content and stored data associated with the policyholder, and (b) fake/real classification.

A further enhancement may be where the document type is vehicle repair invoice, and wherein executing the content verification module to verify the extracted document content includes performing anomaly detection based upon the extracted document content and stored historical vehicle repair invoice data.

A further enhancement may be where the document type is medical care invoice, and wherein executing the content verification module to verify the extracted document content includes performing anomaly detection based upon the extracted document content and stored historical medical care invoice data.

A further enhancement may be where executing the classification module to classify the document as one document type of a plurality of document types includes: (a) generating a confidence score for the document for each of the plurality of document types; (b) ordering the confidence scores; and (c) classifying the document as the one document types based upon the highest confidence score.

In another aspect, a computer-implemented method for classifying and analyzing received claim documents using artificial intelligence is provided. The method is implemented using an IA computer system including at least one processor in communication with at least one memory device. The method includes: (a) receiving, from a user computing device associated with an insurance policyholder, an insurance claim request including (i) image data representing a document associated with an insurance claim, and (ii) an identifier of the insurance claim; (b) executing an extraction module to extract document content of the document from the image data; (c) executing a classification module to classify the document as one document type of a plurality of document types, wherein the classification module applies a document classification model to the extracted document content; (d) executing a content verification module to verify the extracted document content based upon the document type of the document; (e) when the extracted document content is verified: (i) applying the extracted document content to the insurance claim identified by the received identifier to update the insurance claim; (ii) transmitting an insurance claim response to the user computing device indicating the extracted document content was verified and applied to the insurance claim; and (iii) processing the updated insurance claim; and (f) when the extracted document content is not verified: (i) updating the insurance claim identified by the received identifier with a denial indicator; and (ii) transmitting an insurance claim response to the user computing device indicating the insurance claim is denied based upon the extracted document content not being verified.

A further enhancement may be where the method further includes (a) storing, in the at least one memory device, a training set of driver's license document content; (b) executing a training module to train the classification module based upon the training set of driver's license document content; and (c) building the document classification model based upon the training.

A further enhancement may be where the method further includes (a) storing, in the at least one memory device, a training set of vehicle repair invoice document content; (b) executing a training module to train the classification module based upon the training set of vehicle repair invoice document content; and (c) building the document classification model based upon the training.

A further enhancement may be where the method further includes (a) storing, in the at least one memory device, a training set of medical care invoice document content; (b) executing a training module to train the classification module based upon the training set of medical care invoice document content; and (c) building the document classification model based upon the training.

A further enhancement may be where the document type is driver's license, and wherein executing the content verification module to verify the extracted document content includes performing at least one of (a) key point matching based upon the extracted document content and stored data associated with the policyholder, and (b) fake/real classification.

A further enhancement may be where the document type is one of vehicle repair invoice and medical care invoice, and wherein executing the content verification module to verify the extracted document content includes performing anomaly detection based upon the extracted document content and a corresponding one of stored historical vehicle repair invoice data and stored historical medical care invoice data.

A further enhancement may be where the plurality of document types include at least: (a) driver's license, (b) vehicle repair invoice, and (c) medical care invoice, and wherein executing the classification module to classify the document as one document type of the plurality of document types includes: (i) generating a confidence score for the document for each of the plurality of document types; (ii) ordering the confidence scores; and (iii) classifying the document as the one document types based upon the highest confidence score.

In a further aspect, at least one non-transitory computer-readable storage medium having computer-executable instructions embodied thereon is provided. When executed by at least one processor of an image analysis (IA) computer system, the computer-executable instructions cause the at least one processor to: (a) receive, from a user computing device associated with an insurance policyholder, an insurance claim request including (i) image data representing a document associated with an insurance claim, and (ii) an identifier of the insurance claim; (b) execute an extraction module to extract document content of the document from the image data; (c) execute a classification module to classify the document as one document type of a plurality of document types, wherein the classification module applies a document classification model to the extracted document content; (d) execute a content verification module to verify the extracted document content based upon the document type of the document; (e) when the extracted document content is verified: (i) apply the extracted document content to the insurance claim identified by the received identifier to update the insurance claim; (ii) transmit an insurance claim response to the user computing device indicating the extracted document content was verified and applied to the insurance claim; and (iii) process the updated insurance claim; and (f) when the extracted document content is not verified: (i) update the insurance claim identified by the received identifier with a denial indicator; and (ii) transmit an insurance claim response to the user computing device indicating the insurance claim is denied based upon the extracted document content not being verified.

A further enhancement may be where the document classification model includes at least one of a conditional neural network optical character recognition (OCR) model, a long short term memory OCR model, and a template matching model.

A further enhancement may be where executing the classification module to classify the document as one document type of a plurality of document types includes (a) generating a confidence score for the document for each of the plurality of document types; (b) ordering the confidence scores; and (c) classifying the document as the one document types based upon the highest confidence score.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a conditional neural network, a deep learning neural network, a reinforced or reinforcement learning module or program, a long short term memory model, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as historical claim documents and/or sample claim documents of each document type. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning, such as deep learning, reinforced learning, or combined learning. In the exemplary embodiment, verified document content feeds back into the machine learning programs in real-time to update its set of parameters.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In the exemplary embodiment, machine learning techniques are used to extract relevant document content from image data, classify the document based on the document content, and verify the document content.

In the exemplary embodiment, a processing element may be trained by providing it with a large sample of historical and/or sample document content with known characteristics or features, for each document type. Such information may include, for example, text, images, and associated characteristics (e.g., location, size, formatting, etc.). Based upon these analyses, the processing element may learn how to identify characteristics and patterns that may then be applied to classifying and analyzing document content for submitted documents. For example, the processing element may learn to classify documents as one of a plurality of document types, and verify document content based upon historical data.

### Additional Considerations

As will be appreciated based upon the foregoing specification, the above- described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An image analysis (IA) computer system for classifying and analyzing received documents using artificial intelligence, the IA computer system including at least one processor in communication with at least one memory device, the at least one processor programmed to:
receive, from a user computing device, a processing request including (i) image data representing a document associated with an incident report, and (ii) an identifier of the incident report, the incident report being stored within a database;
execute an extraction module to electronically extract content of the document from the image data;
execute a classification module to classify the document as one document type of a plurality of document types, wherein the classification module applies a document classification model to the extracted content;
execute a content verification module to verify the extracted content based upon the document type of the document;
in response to the extracted content being verified by the content verification module:
update the incident report by storing the extracted content within the database linked to the incident report and the received identifier;
transmit a response to the user computing device indicating the extracted content was verified and applied to the identified incident report; and
further process the incident report; and
in response to the extracted content not being verified by the content verification module:
generate a denial indicator and update the incident report by storing the denial indicator within the database linked to the incident report and the received identifier; and
transmit a response to the user computing device indicating the incident report is denied based upon the extracted content not being verified.

2. The IA computer system of claim 1, wherein the plurality of document types include at least: (a) driver's license, (b) vehicle repair invoice, and (c) medical care invoice.

3. The IA computer system of claim 1, wherein the at least one processor is further programmed to:
store, in the at least one memory device, a training set of driver's license document content;
execute a training module to train the classification module based upon the training set of driver's license document content; and
build the document classification model based upon the training.

4. The IA computer system of claim 1, wherein the at least one processor is further programmed to:
store, in the at least one memory device, a training set of vehicle repair invoice document content;
execute a training module to train the classification module based upon the training set of vehicle repair invoice document content; and
build the document classification model based upon the training.

5. The IA computer system of claim 1, wherein the at least one processor is further programmed to:
store, in the at least one memory device, a training set of medical care invoice document content;
execute a training module to train the classification module based upon the training set of medical care invoice document content; and
build the document classification model based upon the training.

6. The IA computer system of claim 1, wherein the document classification model is an artificial intelligence-based model that includes at least one of a conditional neural network optical character recognition (OCR) model, a long short term memory OCR model, and a template matching model.

7. The IA computer system of claim 1, wherein the document type is driver's license, and wherein executing the content verification module to verify the extracted content comprises performing at least one of (a) key point matching based upon the extracted content and stored data associated with the user, and (b) fake/real classification.

8. The IA computer system of claim 1, wherein the incident report includes an insurance claim submitted by a policyholder and associated with an accident, and wherein the document type is a vehicle repair invoice, and wherein executing the content verification module to verify the extracted content further comprises (i) performing anomaly detection based upon the extracted content and stored historical vehicle repair invoice data, and (ii) causing a graphical user interface to be displayed on an administrator computing device including an indication as to whether an anomaly has been detected within the vehicle repair invoice thereby flagging the insurance claim as including fraud.

9. The IA computer system of claim 1, wherein the incident report includes an insurance claim submitted by a policyholder and associated with an accident, and wherein the document type is a medical care invoice, and wherein executing the content verification module to verify the extracted content further comprises (i) performing anomaly detection based upon the extracted content and stored historical medical care invoice data, and (ii) causing a graphical user interface to be displayed on an administrator computing device including an indication as to whether an anomaly has been detected within the medical care invoice thereby flagging the insurance claim as including fraud.

10. The IA computer system of claim 1, wherein executing the classification module to classify the document as one document type of a plurality of document types comprises:
generating a confidence score for the document for each of the plurality of document types;
ordering the confidence scores; and
classifying the document as the one document types based upon the highest confidence score.

11. A computer-implemented method for classifying and analyzing received claim documents using artificial intelligence, the method implemented using an IA computer system including at least one processor in communication with at least one memory device, the method comprising:
receiving, from a user computing device, a processing request including (i) image data representing a document associated with an incident report, and (ii) an identifier of the incident report, the incident report being stored within a database;
executing an extraction module to electronically extract content of the document from the image data;
executing a classification module to classify the document as one document type of a plurality of document types, wherein the classification module applies a document classification model to the extracted content;
executing a content verification module to verify the extracted content based upon the document type of the document;
in response to the extracted content being verified by the content verification module:
updating the incident report by storing the extracted content within the database linked to the incident report and the received identifier;
transmitting a response to the user computing device indicating the extracted content was verified and applied to the identified incident report; and
further processing the incident report; and
in response to the extracted content not being verified by the content verification module:
generating a denial indicator and updating the incident report by storing the denial indicator within the database linked to the incident report and the received identifier; and
transmitting a response to the user computing device indicating the incident report is denied based upon the extracted document content not being verified.

12. The method of claim 11, further comprising:
storing, in the at least one memory device, a training set of driver's license document content;
executing a training module to train the classification module based upon the training set of driver's license document content; and
building the document classification model based upon the training.

13. The method of claim 11, further comprising:
storing, in the at least one memory device, a training set of vehicle repair invoice document content;
executing a training module to train the classification module based upon the training set of vehicle repair invoice document content; and
building the document classification model based upon the training.

14. The method of claim 11, further comprising:
storing, in the at least one memory device, a training set of medical care invoice document content;
executing a training module to train the classification module based upon the training set of medical care invoice document content; and
building the document classification model based upon the training.

15. The method of claim 11, wherein the document type is driver's license, and wherein executing the content verification module to verify the extracted content comprises performing at least one of (a) key point matching based upon the extracted document content and stored data associated with the user, and (b) fake/real classification.

16. The method of claim 11, wherein the document type is one of vehicle repair invoice and medical care invoice, and wherein executing the content verification module to verify the extracted document content comprises performing anomaly detection based upon the extracted document content and a corresponding one of stored historical vehicle repair invoice data and stored historical medical care invoice data.

17. The method of claim 11, wherein the plurality of document types include at least: (a) driver's license, (b) vehicle repair invoice, and (c) medical care invoice, and wherein executing the classification module to classify the document as one document type of the plurality of document types comprises:
generating a confidence score for the document for each of the plurality of document types;
ordering the confidence scores; and
classifying the document as the one document types based upon the highest confidence score.

18. At least one non-transitory computer-readable storage medium having computer-executable instructions embodied thereon, wherein, when executed by at least one processor of an image analysis (IA) computer system, the computer-executable instructions cause the at least one processor to:
receive, from a user computing device, a processing request including (i) image data representing a document associated with an incident report, and (ii) an identifier of the incident report, the incident report being stored within a database;
execute an extraction module to electronically extract content of the document from the image data;
execute a classification module to classify the document as one document type of a plurality of document types, wherein the classification module applies a document classification model to the extracted content;
execute a content verification module to verify the extracted content based upon the document type of the document;
in response to the extracted content being verified by the content verification module:
update the incident report by storing the extracted content within the database linked to the incident report and the received identifier;
transmit a response to the user computing device indicating the extracted content was verified and applied to the identified incident report; and
further process the incident report; and
in response to the extracted content not being verified by the content verification module:
generate a denial indicator and update the incident report by storing the denial indicator within the database linked to the incident report and the received identifier; and
transmit a response to the user computing device indicating the incident report is denied based upon the extracted content not being verified.

19. The at least one non-transitory computer-readable storage medium of claim 18, wherein the document classification model is an artificial intelligence-based model that includes at least one of a conditional neural network optical character recognition (OCR) model, a long short term memory OCR model, and a template matching model.

20. The at least one non-transitory computer-readable storage medium of claim 18, wherein executing the classification module to classify the document as one document type of a plurality of document types comprises:
generating a confidence score for the document for each of the plurality of document types;
ordering the confidence scores; and
classifying the document as the one document types based upon the highest confidence score.
